(19) United States
(12) Patent Application Publication
(10) Pub. No.: US 2021/0307397 A1
(43) Pub. Date: Oct. 7, 2021

(54) HEATING ASSEMBLY AND ELECTRONIC CIGARETTE

(71) Applicant: Shenzhen Buddy Technology Development Co., Ltd., Shenzhen (CN)

(72) Inventor: Xiang LIU, Shenzhen City (CN)

(21) Appl. No.: 17/272,259

(22) PCT Filed: Feb. 2, 2019
(86) PCT No.: PCT/CN2019/074549

§ 371 Date: Feb. 26, 2021

(30) Foreign Application Priority Data
Sep. 21, 2018 (CN) 201811109400.0

(51) Int. Cl. A24F 40/46; A24F 40/57; A24F 40/51

(52) U.S. Cl. CPC A24F 40/46; A24F 40/70; A24F 40/51; A24F 40/57

(57) ABSTRACT

An electronic cigarette including a heating assembly is disclosed. The heating assembly includes: a sword-shaped housing, and a heating temperature control assembly sleeved in an inner cavity of the housing, where the heating temperature control assembly includes a metal heating element and/or a temperature control component located between the metal heating element and the housing.

### TECHNICAL FIELD

The present invention relates to the heating field, and in particular to a heating assembly and an electronic cigarette.

### BACKGROUND

Heating assemblies are frequently used parts in daily consumer goods. Existing heating assemblies have small heating areas, low power, complex structures, and poor insulation performance, which often bring inconvenience to consumers in use and cannot satisfy heating requirements of daily products such as electronic cigarette sticks. What's more, due to their structural design defects, some heating assemblies even cause personal injury to users. Therefore, a heating assembly having a new structure is needed to solve these problems.

### SUMMARY

To solve the above-mentioned technical problems, the present invention provides a heating assembly and an electronic cigarette, so as to solve the problems of a small heating area and a complex structure of an existing heating assembly.

A technical solution provided by the present invention to solve the existing technical problems is a heating assembly, including: a sword-shaped housing, and a heating temperature control assembly sleeved in an inner cavity of the housing, where the heating temperature control assembly includes a metal heating element and/or a temperature control component located between the metal heating element and the housing.

As an improvement of the above solution, the heating temperature control assembly is wrapped with an insulating layer.

As a further improvement of the above solution, the insulating layer is mica paper.

As an improvement of the above solution, the heating element has an integrated symmetrical structure.

As an improvement of the above solution, the heating element is formed by basic units that are arranged at intervals and/or connected in a head-to-tail manner, and the basic units are a combination of at least one of a regular structure and an irregular structure.

As an improvement of the above solution, the housing is made of metal with an integrally formed structure, and an exterior of the housing is polished and/or the housing is electroplated with a nano-Teflon coating.

As a further improvement of the above solution, the housing is made of ceramic with an integrally formed structure, and the sword-shaped housing is provided with a sharp edge on an edge of a blade and/or provided with a blade tip at an end part.

As an improvement of the above solution, the temperature control component is a

K-type thermocouple and/or a TCR temperature control module.

The present invention further provides an electronic cigarette, including any one of the heating assemblies described above.

The present invention brings the following beneficial technical effects: The arrangement of the sword-shaped housing, the metal heating element sleeved in the inner cavity of the housing, and the temperature control module located between the metal heating element and the housing forms a heating assembly having a large heating area and a simple structure, and forms an electronic cigarette.

### BRIEF DESCRIPTION OF DRAWINGS

To describe the technical solutions in the embodiments of the present invention more clearly, the following briefly describes the accompanying drawings required for describing the embodiments.

FIG. 1 is a schematic diagram of an implementation of a heating assembly according to the present invention;

FIG. 2 is a sectional view of the heating assembly in FIG. 1;

FIG. 3 is a schematic diagram of a second implementation of a heating assembly according to the present invention;

FIG. 4 is a sectional view of the heating assembly in FIG. 3;

FIG. 5 is a schematic diagram of an implementation of a heating element according to the present invention;

FIG. 6 is a schematic diagram of a second implementation of a heating element according to the present invention; and

FIG. 7 is a schematic diagram of a third implementation of a heating element according to the present invention.

### DETAILED DESCRIPTION

The following describes the concept, specific structure and technical effects of the present invention with reference to embodiments and accompanying drawings, so as to fully understand the objectives, solutions and effects of the present invention. It should be noted that the embodiments in this application and features of the embodiments may be mutually combined to derive other embodiments not explicitly described. In addition, the descriptions of up, down, left and right used in the present invention are only relative to mutual positional relationships of various components of the present invention in the figures.

### Embodiment 1

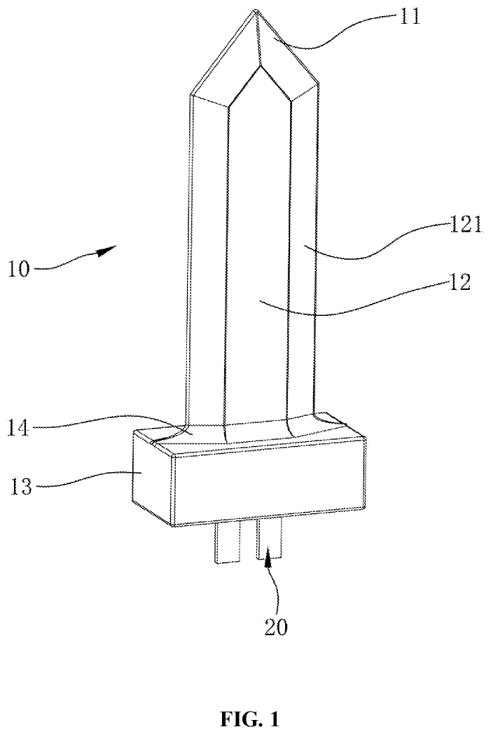

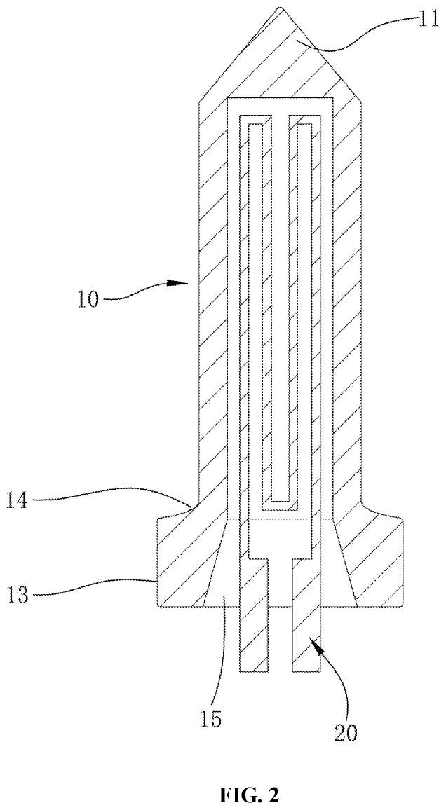

FIG. 1 is a schematic diagram of an implementation of a heating assembly according to the present invention. FIG. 2 is a sectional view of the heating assembly in FIG. 1. Referring to FIG. 1 and FIG. 2, the heating assembly includes a sword-shaped housing 10, and a heating temperature control assembly 20 sleeved in the housing 10, where the heating temperature control assembly 20 is a metal heating element. The housing 10 has a three-stage structure as a whole, including a blade tip 11, a blade 12, and a base 13. A joint surface between the blade 12 and the base 13 is provided with an arc-shaped smooth transition structure 14 to improve strength of the root of the housing 10. A periphery of the blade 12 is provided with a sharp edge 121, and the arrangement of the blade tip 11 and the sharp edge 121 facilitates insertion of the heating assembly into a product (for example, an electronic cigarette stick), or between products to heat the products during actual use.

Preferably, the housing 10 may be integrally formed with a metal material, so that the housing has good uniformity and low processing costs, thereby completely eliminating a problem that the housing is accidentally detached from the base due to heating in comparison with a conventional combined housing and base.

Preferably, the metal housing 10 may be polished and/or electroplated with a nano-Teflon coating to improve heat-resistant performance of the housing, prolong a service life of the housing, and reduce a coefficient of friction on an outer surface of the housing, helping a user insert the heating assembly into a product, for example, into an electronic cigarette stick, to heat the product.

Preferably, the housing 10 may alternatively be made of a food-grade ceramic material with an integrally formed structure, greatly improving insulation performance of the heating assembly.

Further, the heating temperature control assembly 20 is wrapped with an insulating layer formed by mica paper, further improving insulation performance of the heating assembly, and ensuring safety and reliability of the heating assembly.

An open end of the base 13 of the housing 10 is provided with a horn opening 15, which is configured for ceramic glue dispensing to package the heating temperature control assembly inside the housing 10.

### Embodiment 2

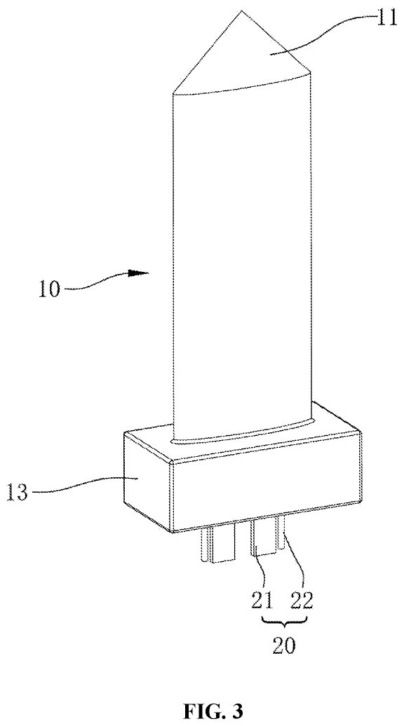

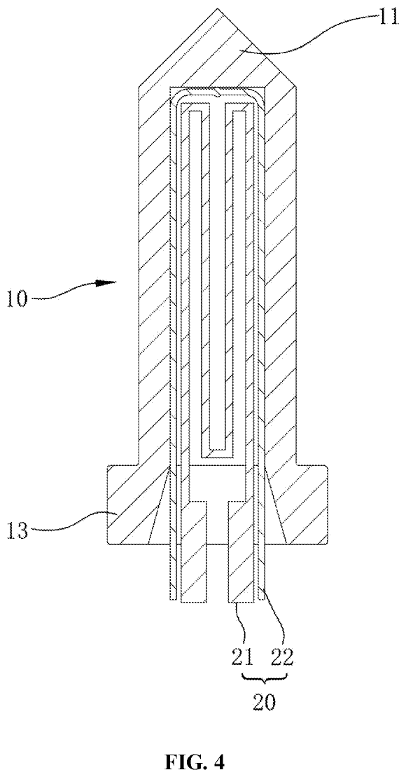

FIG. 3 is a schematic diagram of a second implementation of a heating assembly according to the present invention. FIG. 4 is a sectional view of a heating assembly in FIG. 3. Referring to FIG. 3 and FIG. 4, Embodiment 2 differs from Embodiment 1 in that a housing 10 is of a flat shape, a side surface of the housing is arc-shaped, one end of the housing is provided with a blade tip 11, and a temperature control module 20 includes a metal heating element 21 and a temperature control component 22. The temperature control component 22 is located between the metal heating element 21 and an inner cavity 16 of the housing 10. The temperature control component 22 may be a K-type thermocouple and/or a TCR temperature control module. In comparison with a conventional resistance temperature sensor, the practical temperature control component 22 in the present invention can eliminate a problem of inaccurate temperature measurement of the resistance temperature sensor due to a temperature change, thereby ensuring reliability and stability of the heating assembly. In terms of shape, a structure of another part of the heating assembly is the same as the structure in Embodiment 1, and details are not described herein.

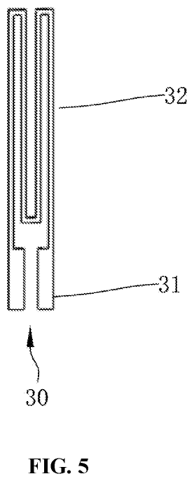

FIG. 5 is a schematic diagram of a first implementation of a heating element in a heating assembly according to the present invention. Referring to FIG. 5, a metal heating element 30 has a symmetrical structure as a whole. A lower part of the metal heating element 30 is provided with two wide sheet-shaped connecting parts 31. There are heating bodies 32 that are connected in a head-to-tail manner and that are approximately S-shaped as a whole between the connecting parts 31, so as to heat the housing of the heating assembly. The metal heating element 30 arranged in this structure uniformly heats up in space, has a simple structure, and is convenient for production and processing. In addition, there is no problem of short circuit when the heating elements are connected to each other, providing high safety and stability.

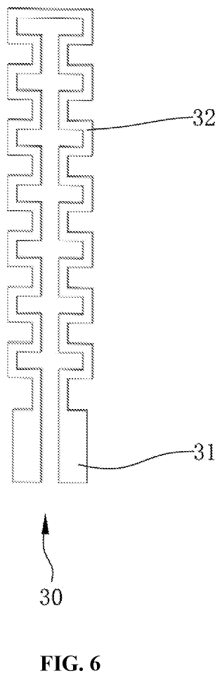

FIG. 6 is a schematic diagram of a second implementation of a heating element in a heating assembly according to the present invention. Referring to FIG. 6, a metal heating element 30 also has a symmetrical structure as a whole. A lower part of the metal heating element 30 is provided with two wide sheet-shaped connecting parts 31. There is a heating body 32 that is formed by a plurality of basic units 40 connected in a head-to-tail manner between the connecting parts 31. The basic units each have a regular and approximately concave-shaped structure. In comparison with a conventional heating wire, the heating body 32 of this structure has a large heating area and a simple structure, and is convenient for production and installation.

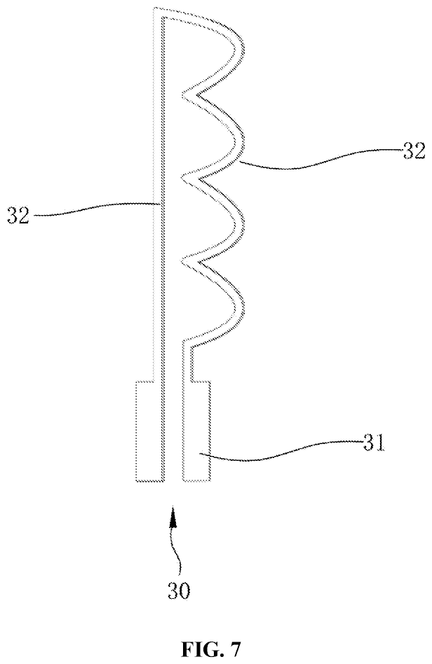

FIG. 7 is a schematic diagram of a third implementation of a heating element in a heating assembly according to the present invention. Referring to FIG. 7, a metal heating element 30 has an asymmetrical structure as a whole. A lower part of the metal heating element 30 is provided with two wide sheet-shaped connecting parts 31. One side of the connecting part 31 is provided with a heating body 32 that is formed by basic units 40 connected in a head-to-tail manner, and the other side of the connecting part 31 is provided with another heating body 32 that is formed by a regular structure. The heating element 30 of this structure can form a stable heating interval at one side, and an alternately changed heating interval at the other side, thereby expanding an application range of the heating assembly in the present invention.

It should be noted that the present invention does not limit the application field of the heating assembly, nor does it limit the structural shape of the basic unit 40 in the heating element 30. The basic unit 40 may be a regular structure such as a triangle, a rectangle, a trapezoid, a parallelogram, an S shape, a concave shape, or a convex shape, or may be an irregular structure. In an actual application process, a regular structure and/or an irregular structure may be freely selected or combined based on a specific application scenario.

The present invention further provides an electronic cigarette, including any heating assembly described above.

It can be learned from the above description that, in the present invention, the arrangement of the sword-shaped housing, the heating element sleeved in the inner cavity of the housing, and the temperature control module located between the metal heating element and the housing forms an easy-to-use heating assembly having a large heating area and a simple structure, and forms an electronic cigarette.

Although the present invention is specifically shown and described with reference to preferred embodiments, a person skilled in the art should understand that various changes, which can be made to the present invention in form and detail without departing from the gist and scope of the present invention defined by the claims, fall within the protection scope of the present invention.

What is claimed is:

1. A heating assembly, comprising: a sword-shaped housing, and a heating temperature control assembly sleeved in an inner cavity of the housing, wherein the heating temperature control assembly comprises a metal heating element and/or a temperature control component located between the metal heating element and the housing.

2. The heating assembly of claim 1, wherein the heating temperature control assembly is wrapped with an insulating layer.

3. The heating assembly of claim 2, wherein the insulating layer is mica paper.

4. The heating assembly of claim 1, wherein the heating element has an integrated symmetrical structure.

5. The heating assembly of claim 4, wherein the heating element is formed by basic units that are arranged at intervals and/or connected in a head-to-tail manner, and the basic units are a combination of at least one of a regular structure and an irregular structure.

6. The heating assembly of claim 1, wherein one side of the heating element is formed by basic units that are arranged at intervals and/or connected in a head-to-tail manner, the other side of the heating element is a regular structure, and the basic units are a combination of at least one of a regular structure and an irregular structure.

7. The heating assembly of claim 1, wherein the housing is made of metal with an integrally formed structure, and an exterior of the housing is polished and/or the housing is electroplated with a nano-Teflon coating.

8. The heating assembly of claim 1, wherein the housing is made of ceramic with an integrally formed structure, and the sword-shaped housing is provided with a sharp edge on an edge of a blade and/or provided with a blade tip at an end part.

9. The heating assembly of claim 1, wherein the temperature control component is a K-type thermocouple and/or a TCR temperature control module.

10. An electronic cigarette, comprising:
a heating assembly comprising:
a sword-shaped housing, and a heating temperature control assembly sleeved in an inner cavity of the housing,
wherein the heating temperature control assembly comprises a metal heating element and/or a temperature control component located between the metal heating element and the housing.

11. The electronic cigarette of claim 10, wherein the heating temperature control assembly is wrapped with an insulating layer.

12. The electronic cigarette of claim 11, wherein the insulating layer is mica paper.

13. The electronic cigarette of claim 10, wherein the heating element has an integrated symmetrical structure.

14. The electronic cigarette of claim 13, wherein the heating element is formed by basic units that are arranged at intervals and/or connected in a head-to-tail manner, and the basic units are a combination of at least one of a regular structure and an irregular structure.

15. The electronic cigarette of claim 10, wherein one side of the heating element is formed by basic units that are arranged at intervals and/or connected in a head-to-tail manner, the other side of the heating element is a regular structure, and the basic units are a combination of at least one of a regular structure and an irregular structure.

16. The electronic cigarette of claim 10, wherein the housing is made of metal with an integrally formed structure, and an exterior of the housing is polished and/or the housing is electroplated with a nano-Teflon coating.

17. The electronic cigarette of claim 10, wherein the housing is made of ceramic with an integrally formed structure, and the sword-shaped housing is provided with a sharp edge on an edge of a blade and/or provided with a blade tip at an end part.

18. The electronic cigarette of claim 10, wherein the temperature control component is a K-type thermocouple and/or a TCR temperature control module.
